(19) United States
(12) Patent Application Publication
(10) Pub. No.: US 2025/0085669 A1
(43) Pub. Date: Mar. 13, 2025

(54) novel method of linking a wearable device for hyper reality visualization

(71) Applicants: Jacob Elmon, London (GB); Brandon Elmon, London (GB)

(72) Inventors: Jacob Elmon, London (GB); Brandon Elmon, London (GB)

(21) Appl. No.: 18/387,920

(22) Filed: Nov. 8, 2023

(30) Foreign Application Priority Data
Sep. 13, 2023 (GB) GB 2313964.5

(51) Int. Cl. G04G 21/04; G06F 1/16; G06F 3/01; G06T 19/00

(52) U.S. Cl. CPC G04G 21/04; G06F 1/163; G06F 3/016; G06T 19/006

(57) ABSTRACT

The present invention relates to hyper reality visualization utilizing a wearable device. More specifically the invention uses a smart tag integrated with Non-Fungible Tokens and associated hyper reality in a wearable device to create a novel user experience.

### FIELD OF INVENTION

The present invention relates to hyper reality visualization utilizing a wearable device. More specifically the invention uses a smart tag integrated with Non-Fungible Tokens and associated hyper reality in a wearable device to create a novel user experience.

### BACKGROUND OF THE INVENTION

Digitalization of physical goods specifically wearable devices is a rapidly evolving field that gives the users an immersive experience through Augmented reality. With recent advancements in technology wearable devices now have the capability provide immersive hyperreality experiences. Augmented-Reality (AR) and Hyper reality are rapidly evolving technologies that combines virtual-reality with the real-world using multimedia, 3D modelling, sensing, real-time tracking and more which allow users to recreate and enhance their surroundings. Wearable devices equipped with tags can serve as a link between the physical and digital worlds, facilitating the integration of NFTs into real-world experiences.

The use of tags in conjunction with wearable devices can enhance the functionality and interactivity of NFTs, allowing for new types of experiences and applications. Non-Fungible Tokens (NFT), built on blockchain technology, provide a way to establish ownership and uniqueness for digital assets, which cannot be replicated and copied as it is unique, valuable and unchangeable in nature.

### DESCRIPTION OF THE RELATED ARTS

Few related arts like U.S. Pat. No. 10,505,726B1 teaches about the cryptographic digital asset that includes a digital shoe and a unique digital shoe ID code. The middleware server computer links the cryptographic digital asset with the unique owner ID code, and records the unique digital shoe ID code and the unique owner ID code on a transaction block with a distributed block chain ledger.

PCT/US2019/019392 pertains to a computer-implemented method for associating one or more wireless security and/or identification tags with augmented reality metadata perceivable on such mobile computing devices.

In US2016054791A1 a system and method for navigating augmented reality (AR) content with a smart watch are described. A head mounted device identifies a watch, maps and generates a display of an AR menu in a transparent display of the head mounted device. The AR menu is displayed as a layer on the watch. The head mounted device detects a physical user interaction on the watch. The head mounted device navigates the AR menu in response to detecting the physical user interaction on the watch.

The present invention describes a novel approach to creating immersive and engaging hyper reality experiences that can be easily accessed and interacted with by users in the real world. The invention provides a wearable device with a unique tag that generates a biofield (electromagnetic field) or a hyper reality field around a person, enabling visualization of NFT or other digital images in the real environment via augmented reality (AR) on compatible devices such as smartphones, VR headsets, or glasses. The invention further includes gamified elements and social interactions that enhance the overall user experience and engagement.

### SUMMARY OF THE INVENTION

The present invention is a method for hyper reality visualization, gamified experiences, and real-world gaming using a wearable device with a unique tag.

In one aspect of the invention, the wearable device, which is a watch, generates a biofield (electromagnetic field) around a person through a unique tag. The biofield is generated by the interaction between the wearable device and the tag, which interfaces to create a hyper reality field around the person wearing the device. This field, when viewed through compatible augmented reality (AR) devices, enables others to experience the augmented environment created by the watch.

In another aspect digital images and virtual objects are projected or displayed directly from the watch. This integration of digital and physical realities is visualised by combining the device with VR headsets, or glasses that can display the AR content based on the signals emitted by the device.

In yet another aspect a software application acts as a linking platform between the wearable device and the real-world gaming experiences, facilitating rewards, leader boards, and social interactions among players. The device combined with the app, display the corresponding AR content on the connected device's screen or compatible glasses. This integration ensures a smooth and interactive AR experience for the user.

In yet another aspect, the wearable device and unique tag enable users to scan and interact with each other's tags in the real world, exchanging virtual items, experiences, or challenges. This includes gamified elements where users can participate in real-world gaming experiences by interacting with the digital images in the real world, capturing virtual objects, completing challenges or missions, and engaging in multiplayer games or competitions while walking around in the real world. This fosters social interactions and enhances the overall user experience, creating a dynamic and engaging hyper reality environment.

The invention presents the unique design and functionality of the wearable device as the conduit or biofield around the user, extending the power of the wearable device beyond the functions of existing NFC technology. The large surface area of the tag enhances the visualization and interactivity of the digital images in the real world, creating a seamless and immersive hyper reality experience for users. The integration with the software application provides a novel approach to linking the wearable device with real-world gaming experiences, creating a unique and engaging user experience.

### BRIEF DESCRIPTION OF THE ACCOMPANYING DRAWINGS

FIG. 1 is an illustration of an exemplary wearable device (NFT watch).

FIGS. 2a and 2b are illustrations of the hyper reality field around the user wearing the NFT watch.

FIG. 3 illustrates flowchart of the workflow algorithm for verifying the wearable device with the blockchain and accessing the metadata.

FIG. 4a represents the network environment of the NFT watch.

FIG. 4b represents a block diagram showing the work flow of the wearable device.

FIG. 5 illustrates a block diagram showing the interaction of wearable device and the software application for multiuser engagement.

FIG. 6 is a diagram illustrating an example ecosystem of a user scanning the tags of other users and their multiple interactions.

Other aspects of the present invention shall be described in further details of the next section.

### DETAILED DESCRIPTION OF THE PREFERRED EMBODIMENTS

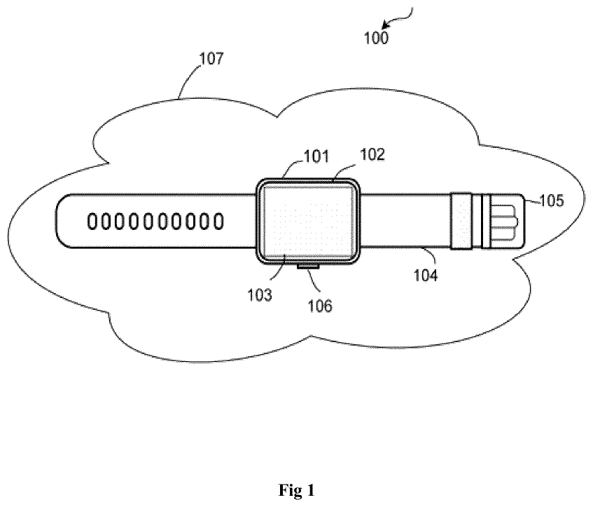

FIG. 1 illustrates an exemplary wearable device 100, presented as a watch, showcasing the emitted hyperreality field 107. The watch 100 consists of a housing 101 and a wrist band 104 connected to the housing. The wrist band 104 can be made of various flexible materials like elastic, fabric, cloth, silicone, leather, or similar options, and may incorporate a fastening mechanism 105 which can be a buckle, clasp, magnetic closure or any other mechanism. The watch features a transparent cover 102 attached to the housing 101, serving as the watch's front face. This cover 102 includes a window or display screen 103, enabling information dissemination to the user (such as time) and acting as an interface for controlling the watch's functionalities. The screen allows users to access NFT images, or augmented reality content. The display can be an LCD (Liquid Crystal Display), OLED (Organic Light-Emitting Diode), or similar technology.

The button 106, which can be located on the housing 101 of the watch 100, serves as a physical input element that enables users to perform specific actions or control different aspects of the watch 100. It can be a movable button or a touch-sensitive area on the watch's surface. The placement and design of the button 106 may vary depending on the watch's form factor and user interface requirements.

The watch 100 incorporates a unique tag within its structure. The tag is seamlessly integrated into the design of the watch and can be located on the wristband 104, clasp 105, or other suitable areas, ensuring its accessibility and functionality. The unique tag which is linked to the NFT provides a robust mechanism for the authentication and ownership verification of digital assets, and an array of unique and collectible virtual objects and artwork that can be experienced through the watch. The tag used in the watch can be a specialized NFC (Near Field Communication) or RFID (Radio Frequency Identification) tag that is capable of generating a hyper reality field. The tag and the watch are carefully designed to interface with each other, allowing the generation of the electromagnetic field or hyperreality field around the person wearing the watch. The watch 100 functions as a conduit or biofield generator, creating the hyperreality field around the person wearing it. This hyperreality field is responsible for creating an interactive and immersive AR environment.

The watch may also incorporate several other key features to provide users with an enhanced augmented reality (AR) experience. It may incorporate various sensors, such as haptic sensors, to enhance the user experience and provide tactile feedback which makes the interactions with the virtual content in the hyper reality environment more realistic. These sensors can be integrated into the watch band or the housing. Other technologies like AI, IoT, BCIs, Quantum computing may be incorporated in the watch to enhance its functionality which enriches user's interactions with the AR content. For example, AI can personalize and adapt the content based on user preferences, IoT can enable interconnected interactions with other devices and objects, BCIs can provide intuitive controls through brainwave analysis, and Quantum computing can enhance computational power for more advanced AR experiences.

The watch can be connected to a software application on a compatible device such as a smartphone or tablet. The app manages the AR experiences and provides a user-friendly interface for selecting and launching different AR content options. The watch transmits signals and data to the app, while the app receives and processes these signals to display the corresponding AR content on the connected device's screen or compatible glasses. This integration ensures a smooth and interactive AR experience for the user.

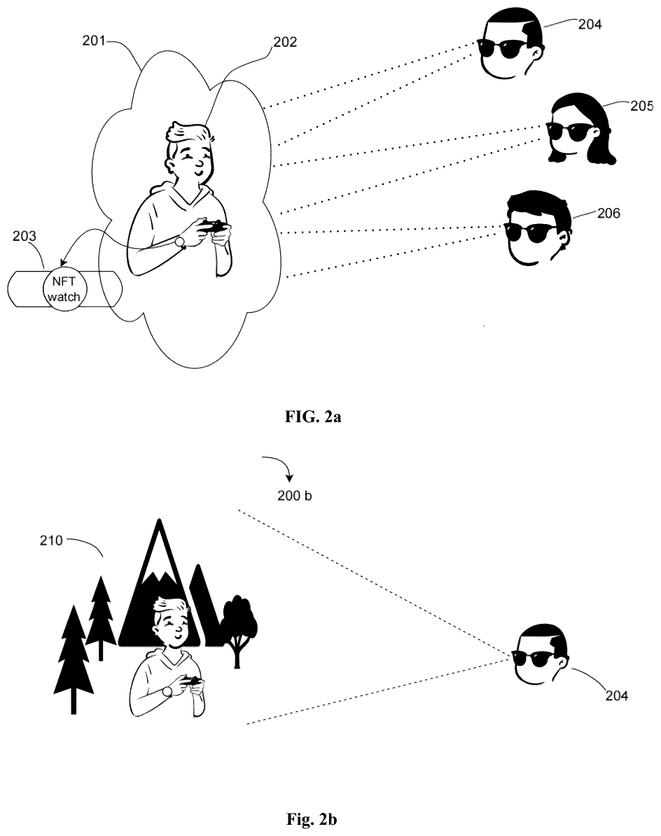

FIG. 2a is an example illustration of the bio field or the hyper reality field 201 projected around the person 202 wearing the NFT watch 203. This hyper reality field 201 is not visible to the naked eye, but can be visualized by the AR such as smartphones, VR headsets, or glasses. Other individuals 204,205and 205 wearing VR glasses can visualize the hyper reality field around the person 202, which is seamlessly integrated into the real physical environment. Virtual objects, or digital information can be displayed within this field, blending with the real-world surroundings.

FIG. 2b is an example of hyper reality with virtual objects 210 surrounding the NFT watch user 202. When the individual 204 observes the user through the VR glasses, he is able to visualize the hyper reality filed with virtual objects 210 as depicted in the example.

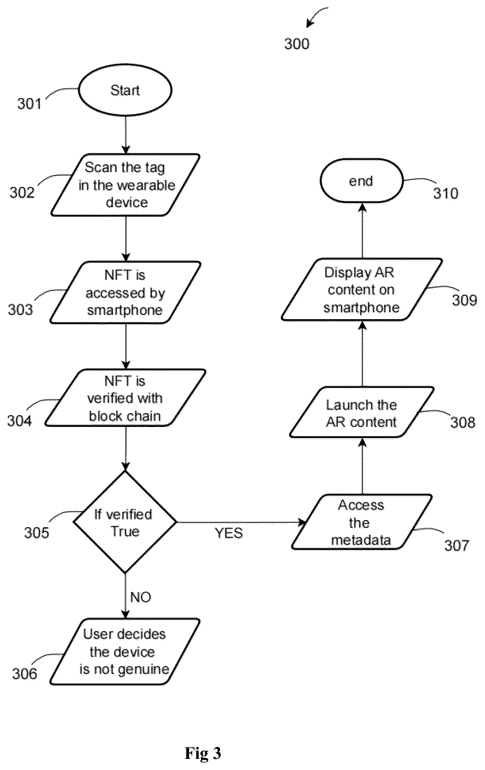

FIG. 3 illustrates flowchart 300 authenticating the wearable device and displaying the corresponding Augmented Reality (AR) content. An NFT (Non-Fungible Token) is a virtual blockchain based digital asset or, a digital certificate for a digital asset. The present flowchart 300 depicts the steps wherein the virtual or digital asset like NFT is linked to a physical wearable device through a specialized NFC/RFID tag. NFT generally connects to a blockchain explorer or a typical online NFT verification mechanism where the NFT displays information for user verification. During the step 302, a user scans the smart tag in the wearable device using a compatible device like smart phone, tablet etc. In step 303, the user accesses the NFT and in step 304 NFT is verified with the block chain network. If At step 305, the user verifies the metadata of the NFT with that of the NFC tag of the wearable device and found it as true then the device is authentic according to step 307, the user can access the metadata of NFT. If the user verifies the NFT and NFC tag data and found it as false incompatible then the user according to the step 306, decides the device is not genuine. Metadata of NFT is a set of data that makes up the content of an NFT, and is usually specified in a JavaScript Object Notation (JSON) format. The metadata of an NFT can describe its name, description, transaction history, traits, link to the hosted image, etc. Once the metadata is accessed, the user can launch the Augmented, Mixed or Hyper reality content associated with the device as in step 308. The AR content is then projected or displayed in the real environment through the connected device's screen, VR headsets, or glasses as in step 309.

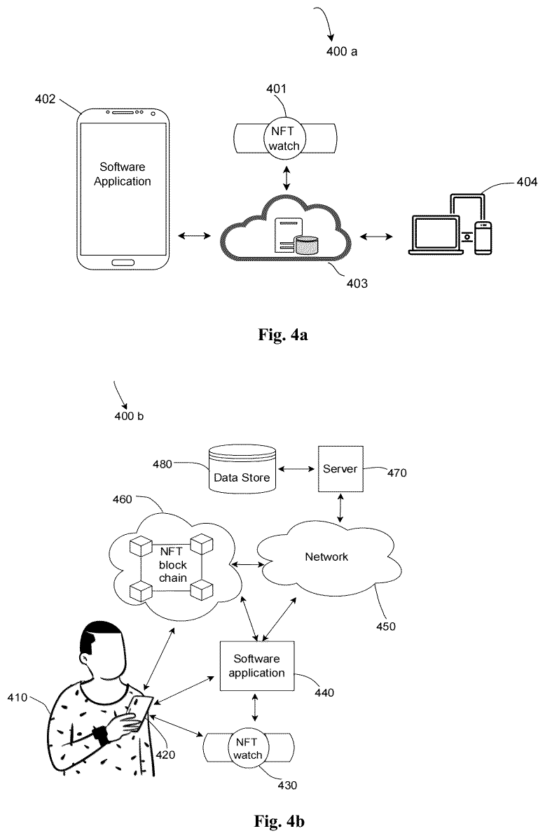

FIG. 4a depicts the network environment of the NFT watch 401. The NFT watch connects to a software application 402 installed on smart devices like smartphones or tablets. This application acts as the user interface for the watch, allowing users to interact with its features and functionalities. Through the application, users can access NFT content, configure settings, and initiate actions on the watch. Within the network environment, there is also a cloud-based data store 403. This data store 403 serves as a centralized repository for storing and managing NFT metadata and other information like ownership data, digital assets, reward points etc. Once the data is stored in the cloud, other devices 404, connected to the same cloud environment can access and retrieve the data as needed. This allows users to seamlessly transfer data between their NFT watch and other devices.

FIG. 4b illustrates an example system 400 b depicting different aspects of the present invention. The system 400b includes a compatible device like a smartphone, tablet etc. which scans the embedded tag in the NFT watch 430. Once the watch is scanned it is verified with the unique NFT block chain 460, the user 410 verifies that the watch is genuine. The watch 430 connects to a software application 440, through which the user is able to visualize the AR. The user is allowed allows to communicate through the network 450 such as the Internet and the data transaction functions carried out by the user is also conducted through the network 450. The smartphone 420 communicates with tag using short-range wireless connections, such as, radio-frequency identification (RFID) or near field communication (NFC). The system also includes at least one server 470 and data store 480.

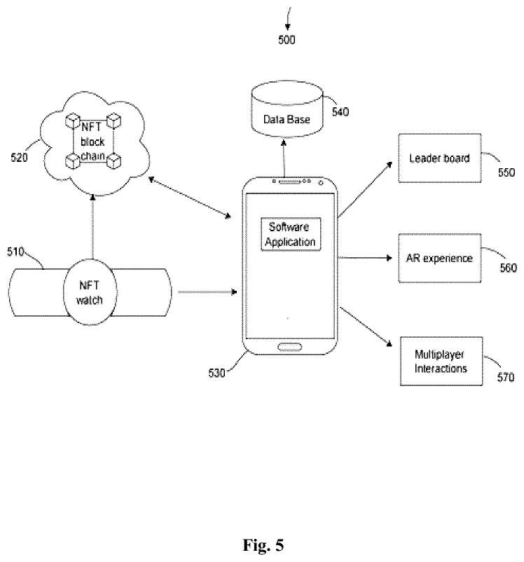

FIG. 5 illustrates a block diagram showing the interaction between the NFT watch 510 and a dedicated software application on compatible device such as a smartphone 530. The NFT watch 510 is scanned by the smartphone 530 and the NFT linked with watch is verified with the blockchain network 520. Once user accesses the software application after scanning the watch 530, the user can navigate through the different sections through the application. The user can access the augmented reality (AR) experience 560 provided with the watch. The software application serves as a central platform for managing the AR experiences and provides a user-friendly interface for selecting and launching different AR content options. The app serves as a platform for real-world gaming experiences, enabling users to participate in interactive gameplay and have multiplayer interactions 570, while wearing the watch. The reward points will be placed on a leader board 550 and the user may be able to redeem the points. The user can also follow other users and could able to see the digital/physical/hybrid assets of the followers and the user itself.

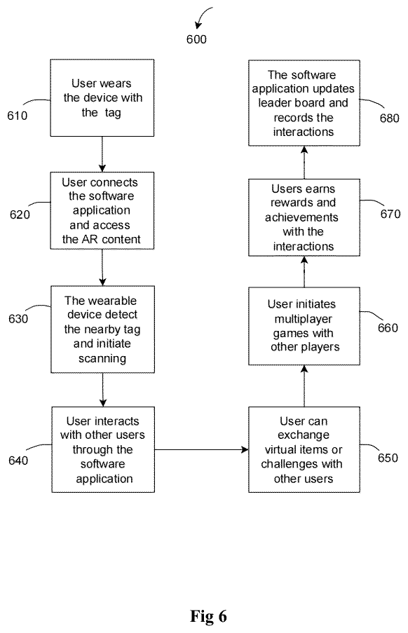

The watch can detect the presence of nearby tags, and upon detection, they initiate the scanning process. FIG. 6 depicts a flow diagram 600, where user interacts with other users wearing the NFT watch. In step 610, a user may wear the NFT watch and as in step 620 can connect it to the dedicated software application on a smartphone by the scanning the tag. The user may also access the augmented reality content through the application. In step 630, the wearable device which is an NFT watch detects nearby tags and initiate scanning. User can bring their watches close to another user's tag to initiate the scanning. As the watch scans the tag, it reads the tag data and retrieves information associated with the scanned user. This information may include the user's profile, virtual representation, or other relevant data. The users can start interacting with each other through the software application as in step 640. The watch's display may present the scanned user's profile or virtual representation, allowing the user to interact with it in various ways. In step 650, user can exchange virtual items, experiences, or challenges with the other users. Through the watch's interface or the software application, users can initiate multiplayer games or competitions as in step 660, further enhancing the interactive experience. Users can also earn rewards and achievements during the multiplayer interactions as in step 670. In step 680 the application server records the interactions and data exchanged with the scanned user, enabling the accumulation of rewards, achievements, and progress tracking.

I/We claim:

1. A wearable device for hyper reality visualization comprising:
a. a watch with wireless tags including Radio Frequency Identification (RFID) tag or a Near Field Communication (NFC) tag integrated within the wristband or its housing;
b. NFC or RFID tags directly linked to Non Fungible Tokens (NFT) for verification of digital assets;
c. a battery powered processor integrated into the watch;
d. a digital display on the front surface of the watch;
e. haptic sensors integrated into the wristband or its housing to provide tactile feedback during user interactions.

2. A wearable device according to claim 1; wherein the NFC or RFID tags interact with the wearable device to generate an electromagnetic biofield or hyper reality field around the user wearing it.

3. A wearable device according to claim 1; wherein the hyper reality field is responsible for creating an interactive and immersive Augmented Reality (AR) environment.

4. A wearable device according to claim 3; wherein the hyper reality field may be visualized by the AR compatible smartphones, Virtual Reality (VR) glasses, or VR headsets.

5. A wearable device according to claim 4; wherein the hyper reality field enables the digital information including virtual objects and NFT imagery, to blended with the real world surroundings which can be further displayed on the watch's display surface.

6. A wearable device according to claim 1; wherein the NFC or RFID tags are linked to a unique Non-Fungible Token providing authentication, ownership and verification of digital assets.

7. A wearable device according to claim 6; wherein the embedded RFID or NFC tag in the NFT watch may be scanned by any smartphone application and verified with the uniquely linked NFT block chain to ascertain the watch's authenticity.

8. A wearable device according to claim 7; which may be connected to a software application that provides a user-friendly interface for displaying Augmented Reality content.

9. A wearable device according to claim 8; wherein the software application manages datasets of augmented reality experiences, rewards, leaderboards, and social interactions.

10. A wearable device according to claim 9; wherein the software application may connect with augmented reality (AR) devices, such as AR headsets or glasses, to view and interact with the augmented reality content.

11. A method for hyper reality visualization; wherein:
a. the NFC or RFID tags are integrated within the wristband or housing of the wearable device;
b. the NFC or RFID tags may interact with the wearable device to generate an electromagnetic biofield or hyper reality field around the user wearing it;
c. the hyper reality field may be visualized by the Augmented Reality (AR) compatible smartphones, Virtual Reality (VR) glasses, or VR headsets to create an interactive and immersive Augmented Reality (AR) environment;
d. the NFC or RFID tags are linked to a unique Non-Fungible Token providing authentication, ownership and verification of digital assets;
e. accessing augmented reality content associated with the wearable device through a software application.

12. A method according to claim 11; wherein the software application facilitates users sharing real-world gaming experiences, rewards, leaderboards, social interactions, and multiplayer interactions among themselves.

13. A method according to claim 12; wherein the users wearing the wearable devices may scan and interact with each other's NFC or RFID tags, exchanging virtual items, experiences, challenges, or engaging in multiplayer games or competitions.
